(19) United States
(12) Patent Application Publication
(10) Pub. No.: US 2012/0311072 A1
(43) Pub. Date: Dec. 6, 2012

(54) MULTIPATH MANAGEMENT ARCHITECTURE AND PROTOCOLS FOR MOBILE MULTIMEDIA SERVICE WITH MULTIPLE DESCRIPTION CODING

(75) Inventors: Xiaolong Huang, San Diego, CA (US); Vijayalakshmi R. Raveendran, San Diego, CA (US); Samir S. Soliman, San Diego, CA (US); Xun Luo, San Diego, CA (US); PhaniKumar K. Bhamidipati, San Diego, CA (US); Soham V. Sheth, San Diego, CA (US)

(73) Assignee: QUALCOMM Incorporated, San Diego, CA (US)

(21) Appl. No.: 13/150,708

(22) Filed: Jun. 1, 2011

(51) Int. Cl. G06F 15/16

(52) U.S. Cl. 709/217

(57) ABSTRACT

A wireless communication method includes an aggregator requesting a first description substream of a multimedia service from a source over a first path, receiving confirmation that the source is available, and receiving a first substream of the service. The method includes determining if a quality of the first substream is satisfactory, and requesting to receive the multimedia service over at least one additional path from the same source. A wireless method of communication by a source device includes receiving a multimedia service request from an end device aggregator over a first path, sending an confirmation that the source is available and sending a first substream over the first path in response to the request. The method includes receiving a request to send the multimedia service over at least one additional path to the end device aggregator from the same source.

### BACKGROUND

1. Field

This invention concerns communication networks, and more particularly, mobile multimedia service in a wireless network.

2. Background

Access links can often become bottlenecks of WWAN (Wireless Wide Area Networks). Currently, multimedia applications on mobile devices increasingly introduce a higher traffic load on access links of WWAN, causing traffic congestion and leading to unsatisfactory user experiences. The capacity of an access link is subject to many constraints, including the physical channel condition, maximum bit rate imposed by the operator based on the service subscription, traffic load on a serving cell, and others. While the capacity of the access link of a primary node may be limited at a time, the primary may be able to use a cooperative node to help enhance its access capacity. More specifically, an out of band link between the primary node and its cooperative node in conjunction with the access link of the cooperative node may provide an alternative path to the WWAN for the primary node's traffic. Hence, multiple paths can be established between a source and its destination. Such multiple paths can be naturally utilized by Multiple Description Coding to provide critical and significant capacity enhancement for a mobile multimedia application.

### SUMMARY

In an aspect of the disclosure, a wireless method of communication by a destination device aggregator includes requesting a multimedia service from a source over a first path, receiving confirmation that the source is available, and receiving a first substream of the service. The method includes determining if a quality of the first substream is satisfactory, and requesting to receive the multimedia service over at least one additional path from the same source.

In an aspect of the disclosure, a wireless method of communication by a source device includes receiving a multimedia service request from an end device aggregator over a first path, sending an confirmation that the source is available and sending a first substream over the first path in response to the request. The method includes receiving a request to send the multimedia service over at least one additional path to the end device aggregator from the same source.

In an aspect of the disclosure, a wireless method of communication by an end device aggregator includes receiving an offer of multimedia service delivery from a source, requesting the multimedia service from a source over a first path, receiving confirmation that the first path is available, and receiving a first substream of the service. The method includes determining if a quality of the first substream is satisfactory and requesting to receive the multimedia service over at least one additional path from the same source.

In an aspect of the disclosure, a wireless method of communication by a source device includes sending an offer of multimedia service delivery to an aggregator, receiving a multimedia service request from an aggregator over a first path, and sending a confirmation that the first path is available. The method includes sending a first substream over the first path in response to the request and receiving a request to send the multimedia service over at least one additional path to the aggregator from the same source.

### BRIEF DESCRIPTION OF THE DRAWINGS

FIG. 1 is an illustration of a general MMS-MDC architecture, in accordance with the disclosure.

FIG. 2 is an illustration of one example case of MMS-MDC.

FIG. 3 is an illustration of a second example case of MMS-MDC.

FIG. 4 illustrates an embodiment of a switching table configuration.

FIG. 5 illustrates an exemplary protocol that can be used to establish the switching table illustrated in FIG. 4.

FIG. 6 illustrates a degenerate protocol that may be used to establish the switching table of FIG. 4 when only the only helpers are source helpers.

FIG. 7 illustrates a degenerate protocol that may be used to establish the switching table of FIG. 4 when only the only helpers are aggregator helpers.

FIG. 8 illustrates an embodiment of a reverse MDC protocol.

FIG. 9 illustrates the configuring of the aggregator helper by the aggregator and the configuring of the source helper by the aggregator helper.

FIG. 10 is a block diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of communication systems will now be presented with reference to various apparatus and methods. These apparatus and methods will be described in the following detailed description and illustrated in the accompanying drawing by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. The computer-readable medium may be a non-transitory computer-readable medium. A non-transitory computer-readable medium may include, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and any other suitable medium for storing software and/or instructions that may be accessed and read by a computer. The computer-readable medium may be resident in the processing system, external to the processing system, or distributed across multiple entities including the processing system. The computer-readable medium may be embodied in a computer-program product. By way of example, a computer-program product may include a computer-readable medium in packaging materials.

A multimedia service may be any service that delivers content end user. Examples of such content may include streaming video, data comprising imagery, data, and the like. A criteria may apply for delivery of the content while meeting a threshold level of quality. Disclosed is an architecture for Mobile Multimedia Service with Multiple Description Coding (MMS-MDC) and a set of protocols for establishing and managing multiple paths between a source and destination of a multimedia stream. Once such multiple paths are established, multiple descriptions of the same multimedia streams can flow through different paths separately between a single source and destination pair, so that the performance of the mobile multimedia application can be enhanced. Some applications that can benefit from the disclosed architecture and protocols include video-on-demand service requested by a mobile device over 3G, live camera feed, video conferencing, and the like.

Some of the aspects of the architecture and the protocols disclosed include: (1) an MMS-MDC multipath architecture for both MDC and reverse MDC streams, (2) a method of helper node discovery for the source and the aggregator of an MDC stream, (3) a multipath establishment architecture and protocols for an MDC stream, (4) a multipath status report and helper node reselection scheme, and (5) a multipath synchronization scheme under the MMS-MDC multipath architecture.

### MMS-MDC Architecture

In an MDC streaming session, node devices involved may have various roles. For example, a node may be a source if it is the traffic source of a streaming session. A node may be an aggregator if it is the traffic destination of a streaming session. A node may be a source helper if it is a cooperative node selected by the source. A node may be an aggregator helper if it is a cooperative node selected by the aggregator. By use of one or more paths including helpers, one or more relay services between the source and aggregator may be established over the paths.

For initiation of an MDC service, the node devices may have various roles. For example, a node may be an initiator if it requests an MDC service. A node may be a target if it responds to an MDC service request.

An exemplary application of an MDC session is a video-on-demand service requested by a node (e.g., a mobile device) over a 3G network, where the mobile device also identifies another 3G device (i.e., a helper), such as a laptop with a data card to assist with receiving this service. The content server in the cloud streams two descriptions, D1 directly to the mobile device and D2 via the helper; the requestor mobile device combines (aggregates) D1 and D2 to obtain better QoE (Quality of Experience).

A reverse MDC session is a streaming session where the source is the initiator. An exemplary application of a reverse MDC session is when a node (e.g., a 3G mobile device) wants to provide a live camera feed to a node (e.g., a PC) in the cloud over a 3G network, and seeks another node (e.g., another 3G mobile device) in the vicinity to “help” upload a second description such that the PC receives a higher QoE.

When both MDC and reverse MDC are at work, a “conversational” application can be supported. An exemplary application of a combination of both MDC and reverse MDC sessions is a conversational application such as a video call between mobile nodes over a 3G network.

### Multipath Establishment Architecture and Protocols for an MDC Stream

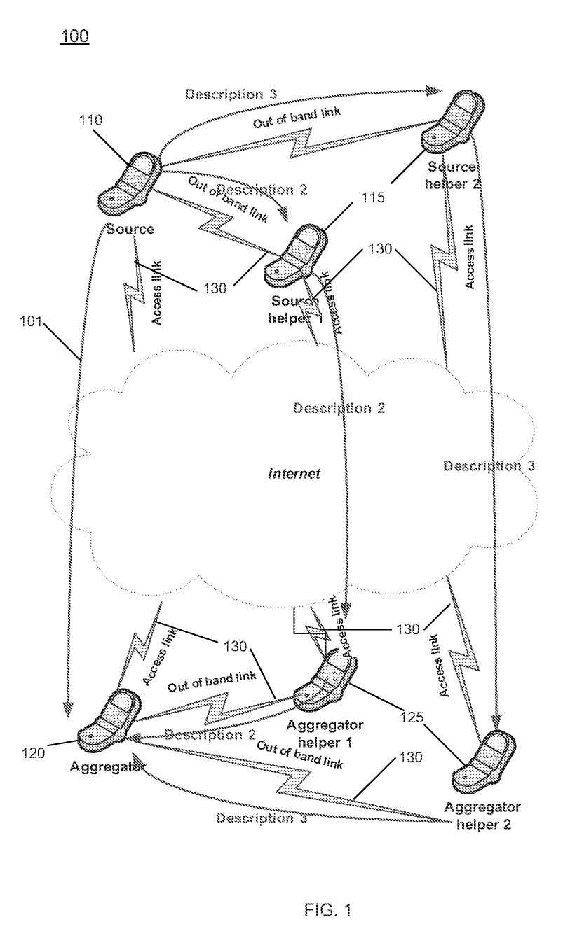

One example of an MMS-MDC architecture 100 in accordance with some aspects of the present disclosure is illustrated in FIG. 1. A source 110 is communicatively coupled with an aggregator 120 by a primary path 101. The coupling may include connection through one or more access links 130 via a WAN, such as the Internet. Further, there may be one or more alternative paths between the source 110 and the aggregator 120 via helpers: That is, the source 110 may select a set of one or more source helpers 115 for its purpose of MDC; the aggregator may select a set of one or more aggregator helpers 125 for its purpose of MDC.

The source 110, the aggregator 120 and their respective helpers 115, 125 may use access links 130 to access a WAN, such as the Internet. The access links 130 may be wireless or wired. For example, an access link 130 may be a wireless air interface to a base station as part of a 3G cellular network. Alternatively, a ground based access link 130 may use a cable modem or DSL, or any suitable link to the WAN/Internet cloud.

Further, the source 110 may be communicatively coupled with its source helpers 115 by one or more out of band links. Similarly, the aggregator 120 may be communicatively coupled with its aggregator helpers 125 by one or more out of band links. The out of band links between the source 110 and its source helpers 115, or between the aggregator 120 and its aggregator helpers 125, may be wireless or wired. Examples of ou-of-band links may include Bluetooth, WLAN, USB cables, etc.

The aggregator 120 and its various aggregator helpers 125 may have transport level links with the source 110. The aggregator 120 and its various aggregator helpers 125 may have transport level links with a single or multiple source helpers 115.

The source 110 and its various source helpers 115 may have transport level links with the aggregator 120. The source 110 and its various source helpers 115 may have transport level links with a single or multiple aggregator helpers 125.

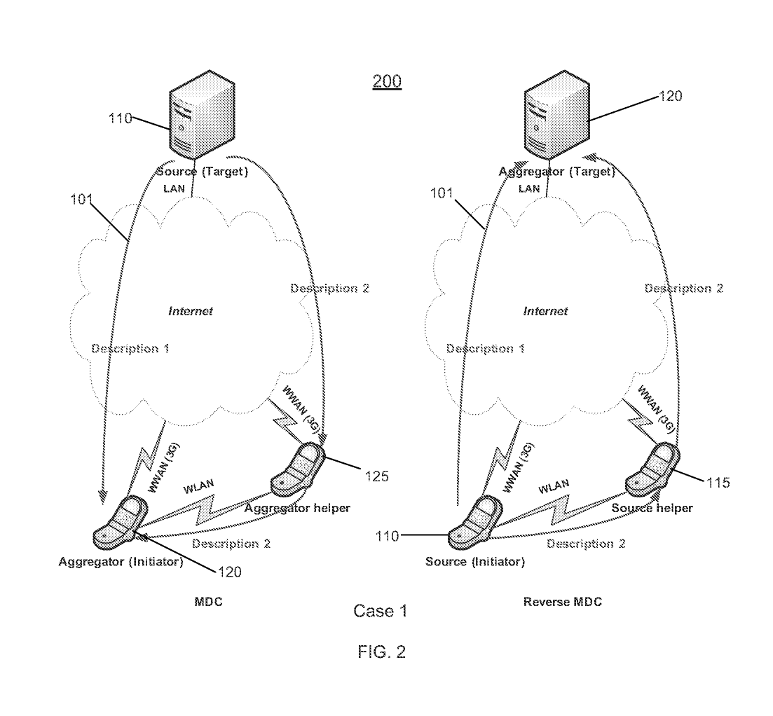

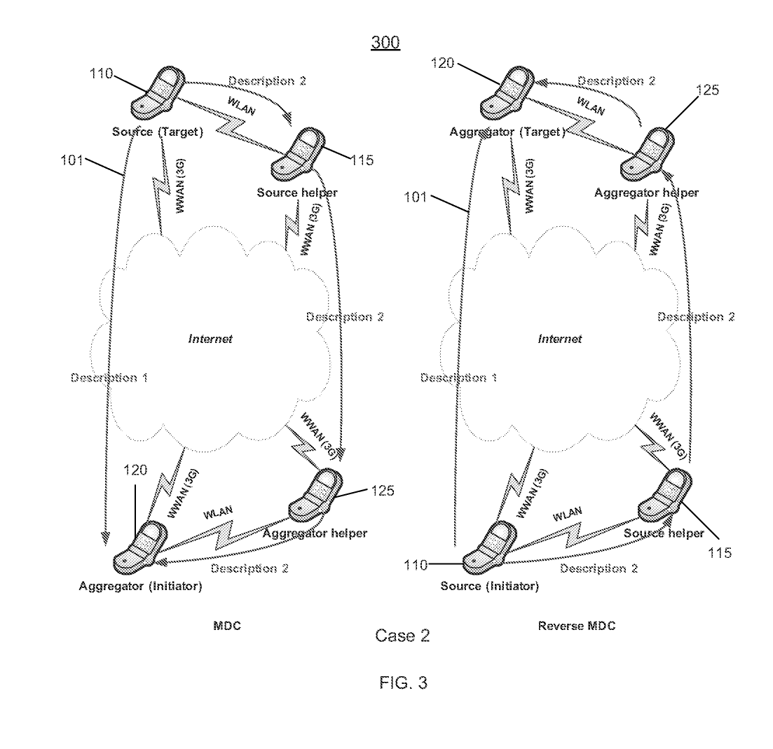

Two typical examples of an MMS-MDC service transaction in accordance with certain aspects of the present disclosure are shown in FIGS. 2 and 3. In case 1 (shown in FIG. 2), an MMS-MDC service transaction 200 includes an alternative path including a single helper (e.g., either source helper 115 or aggregator helper 125), since one end may have sufficient capacity to access the internet and obtain a quality that is greater than a threshold quality. In case 2 (shown in FIG. 3) an MMS-MDC service transaction 300 includes an alternative path including both the source helper 115 and aggregator helper 125, since both ends may benefit from extra bandwidth capacity to obtain a quality that is greater than a threshold quality.

A helper node (e.g., a source helper 115 or an aggregator helper 125), if needed, may be discovered and selected. A node such as a source 110 or aggregator 120 is responsible for discovering and maintaining a list of candidate helpers for itself. That is, the source 110 may discover and maintain a list of source helpers 115, and the aggregator 120 may discover and maintain a list of aggregator helpers 125. The list of candidate helpers may vary depending on the service, and may vary from session to session.

A device can select a candidate to be its helper. In one example, the source 110 may not be able to see any aggregator helpers 125, and the aggregator 120 may not be able to see any source helpers 115. The source 110 and the aggregator 120 may inform each other of their selected helper(s) before establishing the alternative path (when an alternative path requires both helpers).

### Helper Node Discovery

The following criteria can be used for helper discovery and selection. 1) Evaluation of channel conditions: Received carrier to noise plus interference ratio (CINR) in, for example, Wi-Fi, and 3G/4G transmission; received signal strength (Wi-Fi, 3G), and Transmission power or MCS (Wi-Fi, 3G/4G wireless); 2) Evaluation of traffic conditions: Traffic load of the helper node, e.g., via Wi-Fi, and/or 3G/4G; traffic load of the access point (AP) or evolved node B (eNB), e.g., via Wi-Fi, and/or 3G/4G; 3) Evaluation of Interference, such as in downlink channels from serving and neighboring eNBs (such as in, for example, 3G/4G).

The multiple paths between the source 110 and the aggregator 120 can be configured (i.e., established) by installing switching tables at the source helpers 115 and aggregator helpers 125. The source 110 and the aggregator 120 can communicate with their corresponding helpers to setup the switching tables, so that the MDC data packets can be sent by the helpers to the correct node. Signaling between helpers may not be needed for setting up such a switching table.

The switching table entry at a node can be identified by a general combination of the following parameters of the incoming packets:
Transport source 110 address
Transport source 110 port or an incoming virtual path identifier issued by this node
Transport destination (e.g., aggregator 120) address
Transport destination 120 port or an outgoing virtual path identifier issued by the destination
Session ID

The source 110 can send different descriptions, e.g., different portions of a stream of data (e.g., as substreams) via different paths. A common session identifier can be used to identify the common purpose of the multiple descriptions flowing over the multiple paths. The aggregator 120 can subsequently combine the substreams of the multiple descriptions into a single user stream.

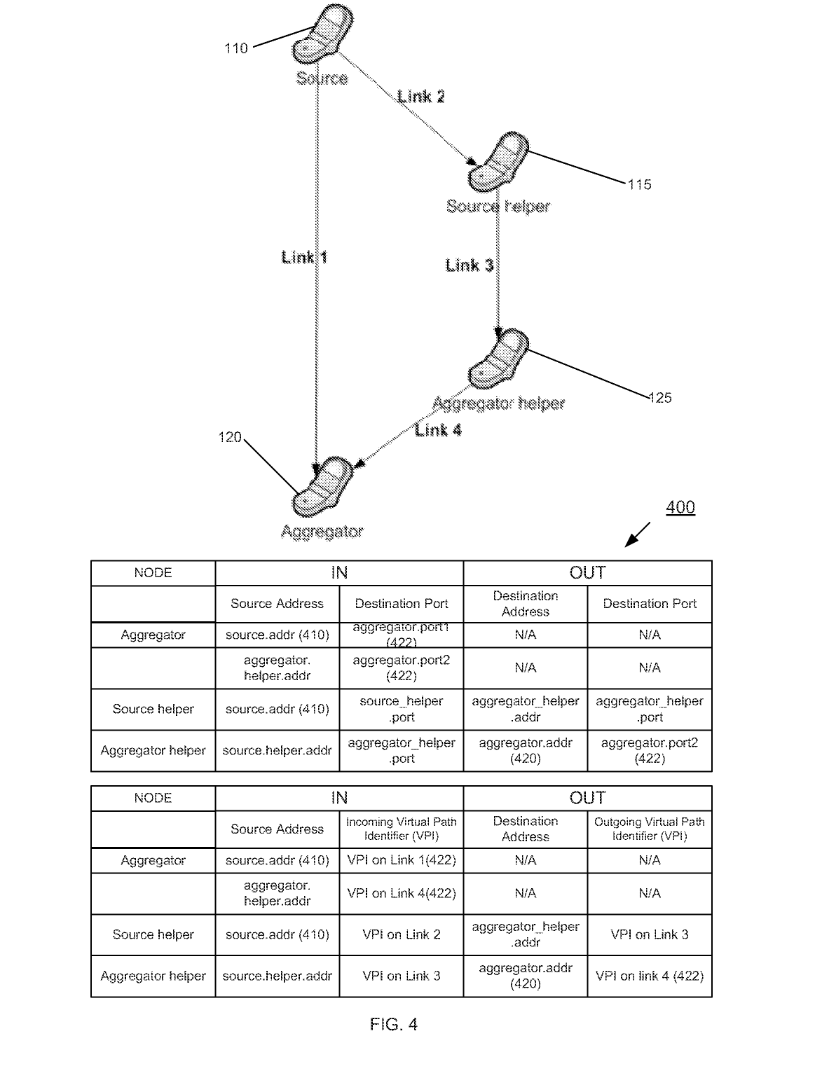

FIG. 4 illustrates an example configuration implementation of a switching table 400, in which a switching table entry at a node is configured with input and output parameters The input parameters include a source address 410 and a destination port 422 or an incoming virtual path identifier issued by this node. The output parameters include a destination address 420 and the destination port 422 or an outgoing virtual path identifier issued by the destination. The virtual path identifier is a well known concept in the literature of ATM and MPLS. The identifier is used to uniquely identify a group of packets receiving by the underlying node which issues the identifier and is contracted to treat this group of packets in a common manner and send this group of packets to a common next hop node. When this group of packets are sent to the next hop node, the identifier should be swapped to another identifier issued by the next hop node. In this manner, data of different descriptions can be transported over different paths from the source 110 to the aggregator 120.

For example, when setting up on overlay network including the source 110, source helper 115, aggregator 120 and aggregator helper (as shown in FIG. 4), the switching table for the aggregator 120 maintains input addressing information, including the source address source.addr 410 from which the media service is originating, the aggregator port aggregator.port1 or the incoming virtual path identifier on Link 1 for receiving the first description D1 (via Link 1), the address of the aggregator helper 125 relaying the second description D2 (via Link 4), and a second input port aggregator.port2 422 or the incoming virtual path identifier on Link 4 assigned for receiving the second description D2. Since the Aggregator is not responsible in this streaming session for forwarding any data, there are no table entries for output addresses or port designations.

In comparison, the aggregator helper 125 maintains a table including on the input side a source helper address sourcehelper.addr to identify the source helper from which D2 is arriving, and a corresponding aggregator helper port aggregator_helper.port or the incoming virtual path identifier on Link 3 set to receive D2 from the source helper 115. On the output side of the table, the aggregator helper has the address aggregator.addr 420 of the aggregator 120 for relaying D2, and the port aggregator.port2 or the outgoing virtual path identifier on Link 4 422 designated by the aggregator 120 for receiving D2. A similar description pertains to the source helper 115 on the input side of the table for identifying the source address 410 from which D2 originates, the input port of the source helper or the incoming virtual path identifier on Link 2 receiving D2, and on the output side for identifying the address and port of the aggregator helper 125 or the outgoing virtual path identifier on Link 3 to receive the relayed D2 sub-stream.

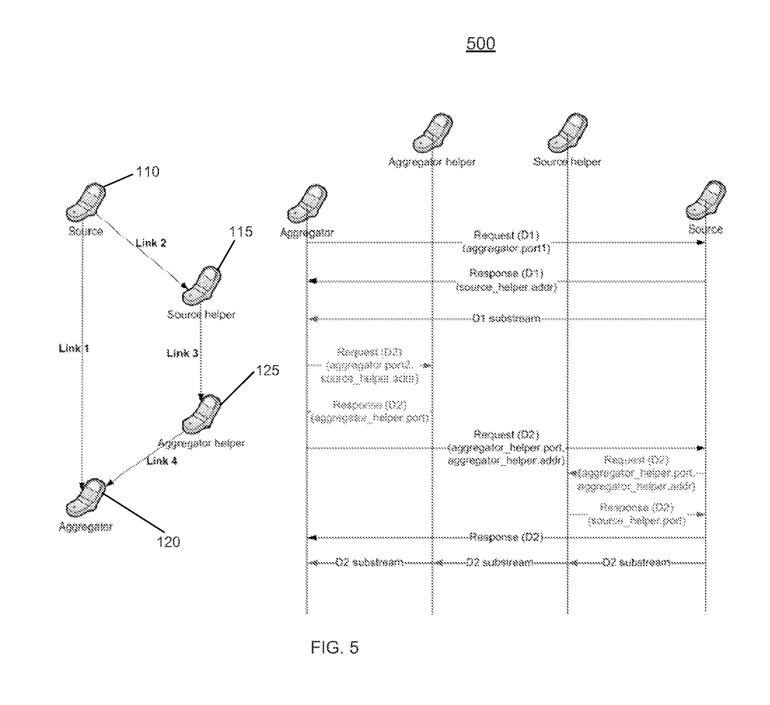

FIG. 5 illustrates an example implementation of a protocol 500 that can be used to establish the switching table 400 illustrated in FIG. 4. In the protocol 500, the aggregator 120 configures the switching table 400 at the aggregator helper 125, while the source 110 configures the switching table 400 at the source helper 115. In the example illustrated in FIG. 5, the aggregator 120 makes a request to receive a first description D1 of a multimedia service from the source 110 having a source address 410. The aggregator provides the aggregator port 422 to the source 110 which the aggregator 120 has requested to receive D1 service delivery. The aggregator sets up a switching table of input information that identifies the source address 410 from which it receives D1 and the aggregator port 422 designated to receive D1.

Upon receiving delivery of the D1 description stream, the aggregator 120 determines if a quality of the D1 description stream being received satisfies a threshold value of quality. If not, the aggregator 120 requests a second description substream D2 of the service. The aggregator 120 seeks to discover, request and select an aggregator helper 125, to provide relay service of the D2 description substream, obtaining an aggregator helper address and aggregator helper port2 422, which it sends to the source 110. The source 110 may, as shown in FIG. 5, discover, request and select a source helper 115, and provide the source helper 125 with switching table entries for aggregator helper port and aggregator helper address to enable the source helper 125 to relay the D2 description substream to the proper aggregator helper 125 and aggregator. The source helper 115, in turn responds to the request from the source with the source helper port to which the source 115 will direct the D2 description substream. The source 110 forwards the source helper address to the aggregator 120, which the latter then provides to the switching table in the aggregator helper 125, in order that the aggregator helper 125 recognizes where the D2 description substream is expected from. Once the switching tables are set up, the D2 description substream is relayed from the source 110 to the source helper 115, the aggregator helper 125, and the aggregator 120.

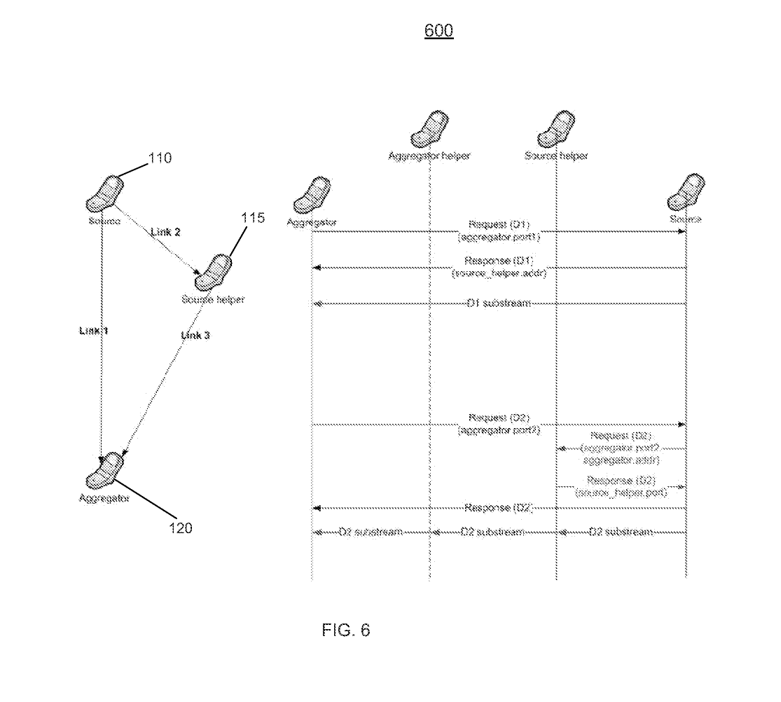

When there are only source helpers 115, a degenerate protocol 600 that can be used to establish the switching table 400 of FIG. 4 is illustrated in the example shown in FIG. 6. In the protocol 600, the source 110 configures the switching table 400 at the source helper 115, while the aggregator 120 has no such responsibility in the absence of an available aggregator helper 125. The protocol of the call flow illustrated in FIG. 6 is simpler than that of FIG. 5, but follows a similar progression of requests, responses and substream delivery, and will not be discussed in further detail.

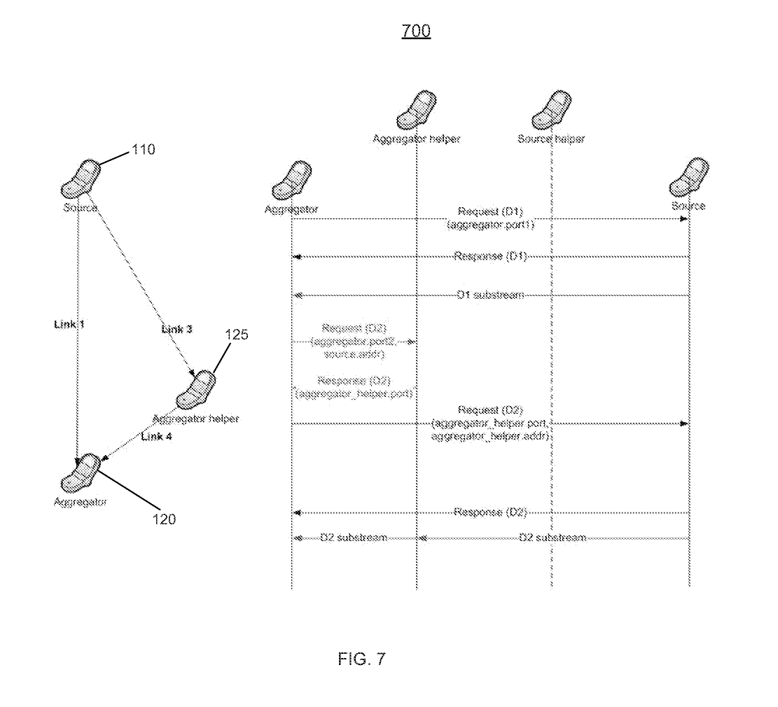

When there are only aggregator helpers 125, a degenerate protocol 700 that can be used to establish the switching table 400 of FIG. 4 is illustrated in the example shown in FIG. 7. In the protocol 700, the aggregator 120 configures the switching table 400 at the aggregator helper 125, while the source 110 has no such responsibility in the absence of an available source helper 115. The protocol of the call flow illustrated in FIG. 7 is simpler than that of FIG. 5, but follows a similar progression of requests, responses and substream delivery, and will not be discussed in further detail.

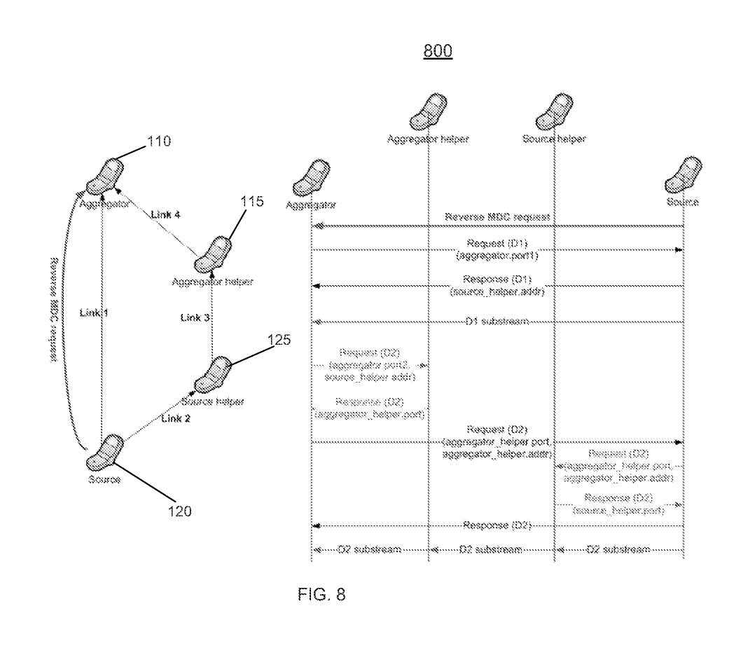

In another aspect of the disclosure, a reverse MDC session may reuse the MDC multipath establishment protocol with additional bootstrapping steps, in which (1) the initiator sends a reverse MDC request offering service to the target, and (2) the target starts the MDC multipath establishment protocol 500 as usual. FIG. 8 is an illustration of a reverse MDC Protocol 800. The protocol of the call flow illustrated in FIG. 8 is similar to that of FIG. 5, and will not be discussed in further detail.

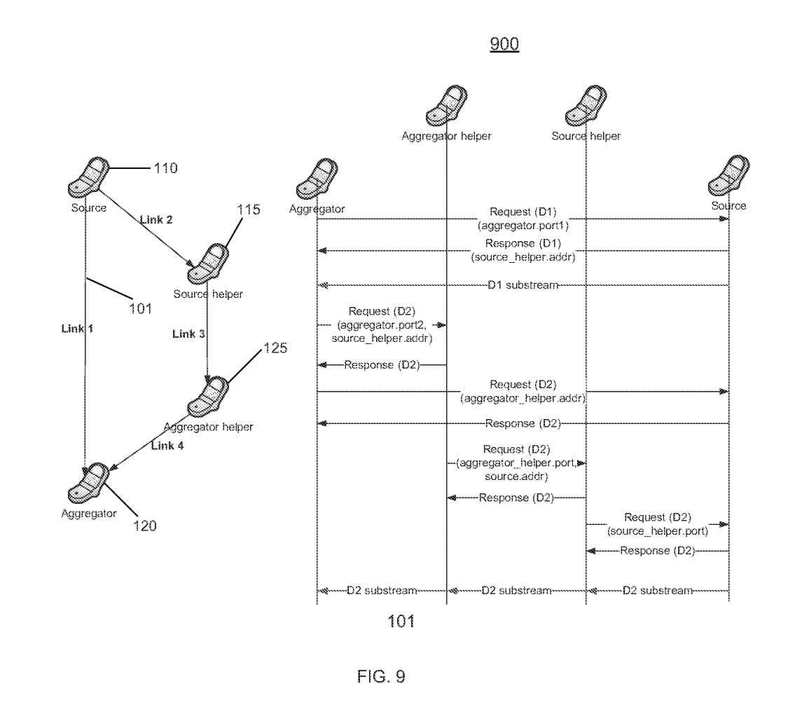

In another aspect of the disclosure, an alternative protocol 900 that can be used to establish the switching table 400 of FIG. 4 is illustrated in FIG. 9, in which the aggregator 120 configures the switching table at the aggregator helper 125, while the aggregator helper 125 configures the switching table at the source helper 115. A case such as this may arise, for example, when both helpers are on the aggregator side of the Internet cloud, such as having the same access point. The protocol of the call flow illustrated in FIG. 9 is similar to that of FIG. 5, and will not be discussed in further detail.

Substream elimination is possible when a helper already has the content requested by an aggregator 120. When an aggregator helper 125 has the content requested by an aggregator 120, the aggregator 120 does not need to send a request for an alternative description to the source 110. Similarly, when a source helper 115 has the content requested by an aggregator 120, the aggregator 120 may configure the switching table 400 of the source helper 115 and identify the substream description to be sent by the source helper 115, but not send any description to the source helper 115.

Stability, delay, and delay jitter of each path is critical to the overall performance of the MDC stream. Hence, it is important to adjust the multipath by helper reselection when necessary based on the status of each path. The following steps may be implemented to maintain the multipath:

### Status Report

The aggregator 120 may monitor the stability, delay, and the delay jitter of each path. The aggregator 120 may report to the source 110 traffic performance on both the primary path and alternative paths. The aggregator 120 may report back status and performance statistics to the source 110 for QoE (Quality of Experience) adaptation. The source 110 may monitor and maintain network and service status. The aggregator 120 and source 110 may coordinate between themselves to maintain overall health of the service.

### Helper Reselection

Depending on the health of the service and helper availability, source/aggregator helper 115/125 reselection may be needed over time, as follows.

The aggregator 120 may reselect an aggregator helper 125 when an original aggregator helper 125 fails in the criteria used for selecting the original aggregator helper 125. Similarly, the source 110 may reselect a source helper 115 when an original source helper 115 fails in the criteria used for selecting the original source helper 115.

### Seamless Path Switching

In order to ensure seamless path switching, if possible, an aggregator helper 125 may continue to function until the aggregator 120 stops it. Similarly, if possible, a source helper 115 may continue to function until the source 110 stops it. When an aggregator helper 125 is changed, the aggregator 120 should send a message to inform the source 110, so that the source 110 can ask the source helper 115 to update its switching table 400 in order to redirect the substream. When a source helper 115 is changed, the source 110 may send a message to inform the aggregator 120, so that the aggregator 120 can ask the aggregator helper 125 to update its switching table 400 to redirect the link to receive the substream.

### Synchronization

The aggregator 120 may report the performance of each description (in a substream) and send the feedback to the source 110. The source 110 may directly synchronize the descriptions on multiple paths. A delay difference among different paths may be used as a parameter to synchronize the descriptions on different paths. The following incidents may be used by the source 110 as triggers for synchronization: performance issues seen at the aggregator 120, aggregator helper 125 reselection, and source helper 115 reselection.

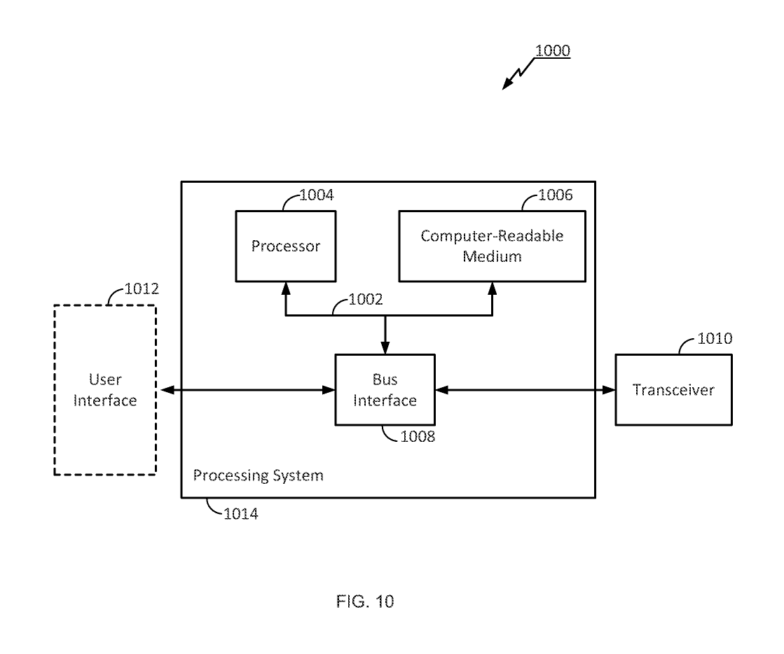

FIG. 10 is a block diagram illustrating an example of a hardware implementation for an apparatus 1000 employing a processing system 114. The apparatus 1000 may be any of the source 110, source helper 115, aggregator 120, aggregator helper 125, and the like. In this example, the processing system 1014 may be implemented with a bus architecture, represented generally by the bus 1002. The bus 1002 may include any number of interconnecting buses and bridges depending on the specific application of the processing system 1014 and the overall design constraints. The bus 1002 links together various circuits including one or more processors, represented generally by the processor 1004, and computer-readable media, represented generally by the computer-readable medium 1006. The bus 1002 may also link various other circuits such as timing sources, peripherals, voltage regulators, and power management circuits, which are well known in the art, and therefore, will not be described any further. A bus interface 1008 provides an interface between the bus 1002 and a transceiver 1010. The transceiver 1010 provides a means for communicating with various other apparatus over a transmission medium. Depending upon the nature of the apparatus, a user interface 1012 (e.g., keypad, display, speaker, microphone, joystick) may also be provided.

The processor 1004 is responsible for managing the bus 1002 and general processing, including the execution of software stored on the computer-readable medium 1006. The software, when executed by the processor 1004, causes the processing system 1014 to perform the various functions described infra for any particular apparatus. The computer-readable medium 1006 may also be used for storing data that is manipulated by the processor 1004 when executing software.

The various concepts presented throughout this disclosure may be implemented across a broad variety of telecommunication systems, network architectures, and communication standards.

By way of example, various aspects may be extended to various UMTS systems such as TD-SCDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A wireless method of communication by an aggregator, comprising:
requesting a multimedia service from a source;
receiving confirmation that the source is available;
receiving a first description substream of the service over a first path; and
requesting to receive over at least one additional path a second description substream of the multimedia service from the source when a quality of the first description substream over the first path is less than a quality threshold.

2. The method of claim 1, further comprising:
selecting an aggregator helper;
requesting a relay service from the aggregator helper;
receiving confirmation that the aggregator helper is available for the relay service; and
conveying information about the aggregator helper to the source for the relay service.

3. The method of claim 2, further comprising:
establishing the at least one additional path from the source to the aggregator via the aggregator helper; and
receiving the second description substream over the at least one additional path when the quality of the first description substream over the first path is less than a quality threshold.

4. The method of claim 3, wherein the at least one additional path comprises an out-of-band link between the aggregator and the aggregator helper.

5. The method of claim 2, wherein the selecting of the aggregator helper further comprises:
discovering a set of one or more candidate aggregator helpers from which the selecting is made; and
maintaining a list of the candidate aggregator helpers.

6. The method of claim 2, wherein the selecting the aggregator helper comprises a criteria, the criteria comprising at least one of one a received carrier to noise plus interference ratio (CINR), a received signal strength, a transmission power, a traffic load at the aggregator helper, a traffic load at an access point or evolved nodeB (eNB) corresponding to the aggregator helper, or a level of interference in downlink channels from serving and neighboring eNBs.

7. The method of claim 3, further comprising receiving information about a source helper prior to establishing the at least one additional path when the source selects a source helper.

8. The method of claim 7, further comprising communicating with the aggregator helper to set up a switching table at the aggregator helper, wherein a second description substream of the service is sent by the source helper to at least one of the aggregator or aggregator helper.

9. The method of claim 8, wherein the switching table at the aggregator helper comprises:
a source helper address parameter;
an aggregator helper input port parameter or an incoming virtual path identifier;
a destination aggregator address parameter;
a destination aggregator output port parameter or an outgoing virtual path identifier; and
a session ID.

10. A wireless method of communication by a source, comprising:
receiving a multimedia service request from an aggregator;
sending a first description substream of the service over a first path in response to the request;
receiving a request to send a second description substream of the multimedia service over at least one additional path to the aggregator from the source when a quality of the first description substream over the first path is less than a quality threshold.

11. The method of claim 10, further comprising sending a confirmation that the source is available after receiving the multimedia service request from the aggregator.

12. The method of claim 11, further comprising:
selecting a source helper;
requesting a relay service from the source helper;
receiving identifying information about an aggregator helper; and
conveying the identifying information about the aggregator helper to the source helper for the relay service.

13. The method of claim 12, further comprising receiving confirmation that the source helper is available for the relay service after requesting the relay service.

14. The method of claim 13, further comprising:
establishing the at least one additional path from the source to the aggregator via the source helper; and
sending the second description substream of the service over the at least one additional path from the source via the source helper.

15. The method of claim 14, wherein the at least one additional path comprises an out-of-band link between the source and the source helper.

16. The method of claim 12, the selecting a source helper further comprising:
discovering a set of one or more candidate source helpers from which the selecting is made; and
maintaining a list of the candidate source helpers.

17. The method of claim 12, wherein a criteria for selecting a source helper comprises determining a received carrier to noise plus interference ratio (CINR), determining a received signal strength, determining a transmission power, determining a traffic load at the aggregator helper, determining a traffic load at an access point (AP) or evolved nodeB (enB) corresponding to the aggregator helper, determining a level of interference in downlink channels from serving and neighboring enBs.

18. The method of claim 14, further comprising the source receiving information about the source helper prior to establishing the alternate path when the source selects the source helper.

19. The method of claim 18, further comprising communicating with the source helper to set up a switching table at the source helper, wherein the second description substream of the service is sent by the source helper to at least one of the aggregator or aggregator helper.

20. The method of claim 18, wherein the source helper switching table comprises:
a source address parameter;
a source helper input port parameter or an incoming virtual path identifier;
an aggregator helper address parameter;
an aggregator helper output port parameter or an outgoing virtual path identifier; and
a session ID.

21. A wireless method of communication by an aggregator comprising:
receiving an offer for delivery of a multimedia service from a source;
requesting the multimedia service from the source;
receiving a first description substream of the multimedia service over a first path;
determining if a quality of the first description substream is less than a quality threshold; and
requesting to receive over at least one additional path a second description substream of the multimedia service from the source when the quality of the first description substream over the first path is less than a quality threshold.

22. The method of claim 21, further comprising receiving confirmation that the source is available after requesting the multimedia service from the source.

23. The method of claim 21, further comprising:
selecting an aggregator helper;
requesting a relay service from the aggregator helper; and
conveying information about the aggregator helper to the source for the relay service.

24. The method of claim 23, further comprising receiving confirmation that the aggregator helper is available for the relay service after requesting the relay service from the aggregator helper.

25. The method of claim 23, further comprising:
establishing the at least one additional path from the source to the aggregator via the aggregator helper; and
receiving the second description substream of the service over the at least one additional path when the quality of the first description substream over the first path is less than a quality threshold.

26. The method of claim 25, wherein the at least one additional path comprises an out-of-band link between the aggregator and the aggregator helper.

27. The method of claim 23, the selecting an aggregator helper further comprising:
discovering a set of one or more candidate aggregator helpers from which the selecting is made; and
maintaining a list of the candidate aggregator helpers.

28. The method of claim 23, wherein the selecting the aggregator helper comprises a criteria, the criteria comprising at least one of one a received carrier to noise plus interference ratio (CINR), a received signal strength, a transmission power, a traffic load at the aggregator helper, a traffic load at an access point or evolved nodeB (eNB) corresponding to the aggregator helper, or a level of interference in downlink channels from serving and neighboring eNBs.

29. The method of claim 25, further comprising receiving information about a source helper prior to establishing the at least one additional path when the source selects a source helper.

30. The method of claim 29, further comprising communicating with the aggregator helper to set up a switching table at the aggregator helper, wherein a second description substream of the service is sent by the source helper to at least one of the aggregator or aggregator helper.

31. The method of claim 29, wherein the switching table at the aggregator helper comprises:
a source helper address parameter;
an aggregator helper input port parameter or an incoming virtual path identifier;
a destination aggregator address parameter;
a destination aggregator output port parameter or an outgoing virtual path identifier; and
a session ID.

32. A wireless method of communication by a source comprising:
sending an offer of multimedia service delivery to an aggregator;
receiving a response from the aggregator accepting the offer by requesting the multimedia service;
sending a confirmation that the source is available;
sending a first description substream of the multimedia service over a first path in response to the request; and
receiving a request to send a second description substream of the multimedia service over at least one additional path to the aggregator from the source when a quality of the first description substream over the first path is less than a quality threshold.

33. The method of claim 32, further comprising:
selecting a source helper;
requesting a relay service from the source helper;
receiving identifying information about an aggregator helper; and
conveying identifying information about the aggregator helper to the source helper for the relay service.

34. The method of claim 33, further comprising receiving a confirmation that the source helper is available for the relay service after requesting the relay service from the source helper.

35. The method of claim 33, further comprising:
establishing the at least one additional path from the source to the aggregator via the source helper; and
sending second description second substream of the service over the at least one additional path from the source via the source helper.

36. The method of claim 35, wherein the at least one additional path comprises an out-of-band link between the source and the source helper.

37. The method of claim 33, the selecting a source helper further comprising:
discovering a set of one or more candidate source helpers from which the selecting is made; and
maintaining a list of the candidate source helpers.

38. The method of claim 33, wherein a criteria for selecting a source helper comprises determining a received carrier to noise plus interference ratio (CINR), determining a received signal strength, determining a transmission power, determining a traffic load at the aggregator helper, determining a traffic load at an access point (AP) or evolved nodeB (enB) corresponding to the aggregator helper, determining a level of interference in downlink channels from serving and neighboring enBs.

39. The method of claim 35, further comprising receiving information about the source helper prior to establishing the alternate path when the source selects the source helper.

40. The method of claim 39, further comprising communicating with the source helper to set up a switching table at the source helper, wherein a second description substream of the service is sent by the source helper to at least one of the aggregator or aggregator helper.

41. The method of claim 39, wherein the source helper switching table comprises:
a source address parameter;
a source helper input port parameter or an incoming virtual path identifier;
an aggregator helper output address parameter;
an aggregator helper output port parameter or an outgoing virtual path identifier; and
a session ID.

42. A wireless method of communication by an aggregator helper comprising:
receiving a multimedia service relay request from an aggregator;
sending confirmation that the aggregator helper is available; and
conveying identifying information about the aggregator helper to the aggregator.

43. The method of claim 42, further comprising sending confirmation that the aggregator helper is available after receiving the multimedia service relay request from the aggregator.

44. The method of claim 43, further comprising:
establishing at least one additional path from the source to the aggregator via the aggregator helper in addition to a path from the source directly to the aggregator;
receiving a description substream of the multimedia service from a source on the basis of the information conveyed about the aggregator helper; and
forwarding the description substream of multimedia service to the aggregator, wherein the path including the aggregator helper is a path in addition to the path from the source directly to the aggregator.

45. The method of claim 44, wherein the at least one additional path comprises an out-of-band link between the aggregator and the aggregator helper.

46. The method of claim 43, wherein establishing the at least one additional path further comprises setting up a switching table at the aggregator helper, wherein a description substream of the service is sent to the aggregator.

47. The method of claim 46, wherein the aggregator helper switching table comprises;
a source helper address parameter;
an aggregator helper input port parameter or an incoming virtual path identifier;
a destination aggregator address parameter;
a destination aggregator output port parameter or an outgoing virtual path identifier; and
a session ID.

48. A wireless method of communication by a source helper comprising:
receiving a multimedia service relay request from a source; and
conveying identifying information about the source helper to the source.

49. The method of claim 48, further comprising sending a confirmation that the source helper is available.

50. The method of claim 49, further comprising:
establishing at least one additional path from the source to the aggregator via the source helper in addition to a path from the source directly to the aggregator;
receiving a description substream of multimedia service from a source on the basis of the information conveyed about the source helper; and
forwarding the description substream of multimedia service to the aggregator, wherein the path including the source helper is a path in addition to the path from the source directly to the aggregator.

51. The method of claim 50, wherein the at least one additional path comprises an out-of-band link between the aggregator and the aggregator helper.

52. The method of claim 50, wherein establishing the at least one additional path further comprises setting up a switching table at the source helper, wherein a description substream of the service is sent to at least one of the aggregator helper or aggregator.

53. The method of claim 52, wherein the source helper switching table comprises;
a source address parameter;
an source helper input port parameter or an incoming virtual path identifier;
a destination aggregator output address parameter;
a destination aggregator output port parameter or an outgoing virtual path identifier; and
a session ID.

54. An aggregator for wireless communication, comprising:
means for requesting a multimedia service from a source over a first path;
means for receiving a first description substream of the multimedia service;
means for requesting to receive over at least one additional path a second description substream of the multimedia service from the source when a quality of the first description substream received over the first path is less than a quality threshold.

55. The aggregator of claim 54, further comprising means for receiving confirmation that the source is available after receiving confirmation that the source is available.

56. A source for wireless communication, comprising:
means for receiving a multimedia service request from an aggregator;
means for sending a first description substream of the multimedia service over a first path in response to the request; and
means for receiving a request to send a second description substream of the multimedia service over at least one additional path to the aggregator from the source when a quality of the first description substream sent over the first path is less than a quality threshold.

57. The source of claim 56, further comprising means for sending a confirmation that the source is available after receiving the multimedia service request from the aggregator.

58. An aggregator for wireless communication comprising:
means for receiving an offer of multimedia service delivery from a source;
means for requesting the multimedia service from a source;
means for receiving a first description substream of the multimedia service over a first path;
means for determining if a quality of the first substream is satisfactory; and
means for requesting to receive a second description substream of the multimedia service over at least one additional path from the source when a quality of the first description substream received over the first path is less than a quality threshold.

59. The aggregator of claim 58, further comprising means for receiving confirmation that the source is available after requesting the multimedia service from the source.

60. A source for wireless communication comprising:
means for sending an offer of multimedia service delivery to an aggregator;
means for receiving a multimedia service request from an aggregator over a first path;
means for sending a first description substream of the multimedia service over the first path in response to the request; and
means for receiving a request to send a second description substream of the multimedia service over at least one additional path when a quality of the first description substream received over the first path is less than a quality threshold.

61. The source of claim 60, further comprising means for confirming that the first path is available after receiving the multimedia service request from the aggregator.

62. An aggregator helper for wireless communication comprising:
means for receiving a multimedia service relay request from an aggregator; and
means for conveying identifying information about the aggregator helper to the aggregator.

63. The aggregator of claim 62, further comprising means for sending confirmation that the aggregator helper is available after receiving the multimedia service relay request from the aggregator.

64. A source helper for wireless communication comprising:
means for receiving a multimedia service relay request from a source; and
means for conveying identifying information about the source helper to the source.

65. The source helper of claim 64, further comprising means for sending confirmation that the source helper is available after receiving the multimedia service relay request from the source.

66. A computer program product in a wireless aggregator, comprising:
a non-transitory computer-readable medium comprising code for:
requesting a multimedia service from a source;
receiving a first description substream of the multimedia service over a first path; and
requesting to receive a second description substream of the multimedia service over at least one additional path from the source when a quality of the first description substream received over the first path is less than a quality threshold.

67. The computer program product of claim 66, further comprising receiving confirmation that the source is available after requesting the multimedia service from the source.

68. A computer program product in a wireless source, comprising:
a non-transitory computer-readable medium comprising code for:
receiving a multimedia service request from an aggregator;
sending a first description substream of the multimedia service over a first path; and
receiving a request to send a second description substream of the multimedia service over at least one additional path to the aggregator from the source.

69. The computer program product of claim 68, further comprising sending an confirmation that the source is available after receiving the multimedia service request from the aggregator.

70. A computer program product in a wireless aggregator helper, comprising:
a non-transitory computer-readable medium comprising code for:
receiving a multimedia service relay request from an aggregator; conveying identifying information about the aggregator helper to the aggregator;
receiving a description substream of the multimedia service over a path; and
relaying the description substream of the multimedia service to the aggregator.

71. The computer program product of claim 70, further comprising sending a confirmation that the aggregator helper is available after receiving the multimedia service relay request from the aggregator.

72. A computer program product in a wireless source helper device, comprising:
a non-transitory computer-readable medium comprising code for:
receiving a multimedia service relay request from a source;
conveying identifying information about the source helper to the source;
receiving a description substream of the multimedia service over a path; and
relaying the description substream of the multimedia service to at least one of an aggregator helper or an aggregator.

73. The computer program product of claim 72, further comprising sending confirmation that the source helper is available after receiving the multimedia service relay request from the source.

74. An aggregator apparatus for wireless communication, comprising:
a processing system configured to:
request a multimedia service from a source over a first path;
receive a first substream of the service;
determine if a quality of the first substream is satisfactory; and
request to receive the multimedia service over at least one additional path from the same source.

75. The apparatus of claim 74, the processor further configured to receive confirmation that the source is available after the request of the multimedia service from the source over the first path.

76. A source apparatus for wireless communication, comprising:
a processing system configured to:
receive a multimedia service request from an aggregator;
send a first substream over a first path in response to the request; and
receive a request to send a second description substream of the multimedia service over at least one additional path to the aggregator from the source when a quality of the first description substream sent over the first path is less than a quality threshold.

77. The source apparatus of claim 76, the processing system further configured to send a confirmation that the source is available after receiving the multimedia service request from the aggregator.

78. A aggregator helper apparatus for wireless communication, comprising:
a processing system configured to:
receive a multimedia service relay request from an aggregator;
convey identifying information about the aggregator helper to the aggregator;
receive a description substream of the multimedia service over a path; and
relay the description substream of the multimedia service to the aggregator.

79. The aggregator helper apparatus of claim 78, the processing system further configured to send a confirmation that the aggregator helper is available after receiving the multimedia service relay request from the aggregator.

80. A source helper apparatus for wireless communication, comprising:
a processing system configured to:
receive a multimedia service relay request from a source;
send confirmation that the source helper is available;
convey identifying information about the source helper to the source.
receive a description substream of the multimedia service over a path; and
relay the description substream of the multimedia service to at least one of an aggregator helper or an aggregator.

81. The source helper apparatus of claim 80, the processing system further configured to send confirmation that the source helper is available after receiving the multimedia service relay request from the source.
